(19) United States
(12) Patent Application Publication
(10) Pub. No.: US 2009/0094636 A1
(43) Pub. Date: Apr. 9, 2009

(54) Method and system for providing advertisements in digital broadcasting system

(75) Inventor: Ji-Young LEE, Seoul (KR)

Correspondence Address: EDWARDS ANGELL PALMER & DODGE LLP, P.O. BOX 55874, BOSTON, MA, 02205, US

(73) Assignee: ALTICAST CORPORATION, Seoul (KR)

(21) Appl. No.: 12/245,767

(22) Filed: Oct. 5, 2008

(30) Foreign Application Priority Data
Oct. 5, 2007 (KR) 10-2007-0100279

(51) Int. Cl. H04N 7/025

(52) U.S. Cl. 725/32

(57) ABSTRACT

A method and a system for providing an advertisement in a digital broadcasting are disclosed. The method provides the advertisement in a broadcasting system coupled to at least one broadcasting terminal through a network. In addition, the method includes generating a video source for a program guide by processing a video signal for plural broadcasting programs and at least one advertisement, encoding the generated video source by using predetermined algorithm, and transmitting the encoded video source to the broadcasting terminal or terminals. The broadcasting terminal outputs the program guide having one or more advertisement sub-video included in the video source. As a result, various advertisements may be provided through the program guide.

### CROSS-REFERENCE TO RELATED APPLICATIONS

This application claims priority from Korean Patent Application No. 2007-100279 filed on Oct. 5, 2007, the contents of which are incorporated herein by reference in its entirety.

### TECHNICAL FIELD

The present disclosure relates to a method and a system for providing an advertisement in a digital broadcasting system, more particularly a method and a system for providing various digital advertisements through a program guide.

### RELATED ART

Digital broadcasting services have been actively studied according as users require high definition broadcasting, an interactive broadcasting and various additional services.

Standardization of the digital broadcasting has been developed, including European digital video broadcasting-multimedia home platform (Hereinafter, referred to as “DVB-MHP”) and American advanced television systems committee-digital TV application software environment (Hereinafter, referred to as “ATSCDASE”).

With the development of the standardization of the digital broadcasting, a broadcasting signal having a video signal, an audio signal and a data signal can be compressed to a digital signal. As a result, multi-channel may be applied in TV broadcasting. In addition, various programs may be provided in one channel due to increase of transmission rating.

According as various applications have been developed, data broadcasting services are available, in which a broadcasting and data (additional information) related to the broadcasting are provided, such as weather service, news service, stock service, email service, electric program guide (EPG) service, TV shopping service, banking service, call service and Internet search service.

Through compression of the data, the data broadcasting may be provided with improved picture quality. However, the data broadcasting has a problem in that channel changing velocity becomes slower than that of the analog broadcasting due to a time for downloading broadcasting programs of a channel selected by a user or a time for loading applications for the data broadcasting, etc.

Users change channels using a channel up/down key. Many channels exist and the channel changing velocity is slow in the digital broadcasting. To enable a rapid channel search, most of digital broadcasting systems provide an EPG.

Typically, the digital broadcasting systems receive a video signal concerning a program broadcasted presently through an EPG generating section, process the video signal (e.g., by converting it the signal to one having a smaller size), and provide the EPG in accordance with the processed result so that the user verifies easily video name and channel name concerning the program broadcasted presently and program information, etc.

The EPG is provided with mosaic type, and one EPG is usually made up of about twelve or sixteen sub-videos. Here, since one EPG has a limited number of sub-videos, different EPGs should be generated in case that many broadcasting channels exist. Then, the generated EPGs are respectively transmitted to corresponding broadcasting terminal through different channels. In addition, in order to change the arrangement of the broadcasting program included in one EPG, extra EPG may have to be generated.

Accordingly, in the conventional technique, since there are many channels provided and many transmission channels are required to provide a number of different EPGs arranged with various types for the same broadcasting program, loss of bandwidth occurs.

In the conventional technique, advertisement services are provided through the EPG for channel search. In this case, a digital broadcasting system generates an EPG in which an advertisement sub-video or sub-videos are inserted, and then the generated EPG is received and outputted by broadcasting terminals. Here, every broadcasting terminal outputs the same advertisement sub-video or sub-videos, and the EPG is shown in a small area. Since the EPG is uniformly generated and outputted, the advertisement services do not reflect user preferences, however.

The above information disclosed in this Related Art section is only for enhancement of understanding of the background of the invention and therefore it may contain information that does not form the prior art that is already known in this country to a person of ordinary skill in the art.

### SUMMARY OF DISCLOSURE

Accordingly, the present invention is provided to substantially obviate one or more problems due to limitations and disadvantages of the related art.

In one aspect, the present invention provides a method of providing an advertisement in a broadcasting system coupled to at least one broadcasting terminal through a network, the method comprising: generating a video source for a program guide by processing a video signal for at least one broadcasting program and at least one advertisement; encoding the generated video source by using a predetermined algorithm; and transmitting the encoded video source to the broadcasting terminal or terminals, wherein the broadcasting terminal outputs a program guide having one or more of advertisement sub-videos included in the video source, the advertisement sub-video or sub-videos being selected in accordance with a predetermined condition.

In another aspect, the present invention provides a method of providing an advertisement in a broadcasting terminal for executing a broadcasting program transmitted from a broadcasting system through a network, the method comprising: receiving a video source for a program guide from the broadcasting system through the network, wherein the video source has sub-videos (broadcasting sub-video and advertisement sub-video) for at least one broadcasting programs and at least one advertisement, and is encoded by a preset algorithm; and outputting the program guide having one or more of advertisement sub-videos included in the video source, the advertisement sub-video or sub-videos being selected in accordance with a predetermined condition.

In still another aspect, the present invention provides a system for providing a broadcasting service to at least one broadcasting terminal through a network, the system comprising: a video source generating section configured to generate a video source by processing a video signal for at least one broadcasting program and at least one advertisement; and a source encoding section configured to encode the generated video source by using a preset algorithm, wherein the broadcasting terminal outputs a program guide having one or more of advertisement sub-videos included in the video source, the advertisement sub-video or sub-videos being selected in accordance with a predetermined condition.

In a further aspect, the present invention provides a computer-readable storage medium storing a program for implementing the above-described methods.

The methods and systems of the present invention can provide various advertisements according to user preferences and without imposing excessive load on a digital broadcasting system.

The above and other aspects and features of the present invention will be discussed infra.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating a broadcasting system according to one example embodiment of the present invention;

FIG. 2 is a block diagram illustrating a digital data broadcasting system according to one example embodiment of the present invention;

FIG. 3 is a block diagram illustrating a broadcasting terminal according to one example embodiment of the present invention;

FIG. 4 is a view illustrating a video source for a program guide according to one example embodiment of the present invention;

FIG. 5 is a view illustrating a program guide according to one example embodiment of the present invention; and

FIG. 6 is a flowchart illustrating a process of providing an advertisement through the program guide according to one example embodiment of the present invention.

### DETAILED DESCRIPTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or configurations, but do not preclude the presence or addition of one or more other features, integers, steps, operations, elements, configurations, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

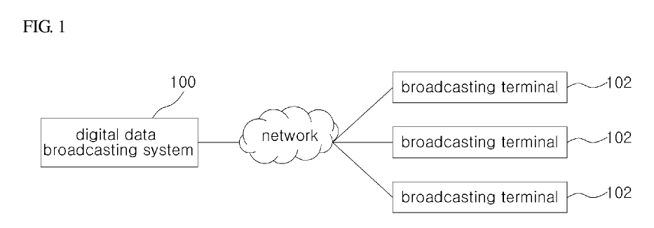

FIG. 1 is a block diagram illustrating a broadcasting system according to one example embodiment of the present invention.

In FIG. 1, the broadcasting system 100 is coupled to at least one broadcasting terminal 102 through a network. Here, the network includes, for example, a wire network having an Internet and an exclusive line, and a wireless network having a wireless Internet, a mobile communication network, a broadcasting network and a satellite communication network. Hereinafter, the network is assumed as the broadcasting network in that a broadcasting signal is provided through the network.

The broadcasting system 100 converts a video signal and an audio signal for broadcasting program of various channels into a proper format, and then transmits the converted signal or signals to the broadcasting terminal 102.

In addition, the broadcasting system 100 performs a scheduling function about the broadcasting program and a scrambling function for blocking access of other people except a subscriber.

Furthermore, the broadcasting system 100 may include extra communication server, (e.g. a return path server) for the purpose of processing requests of a user through an uplink channel to provide Internet service and other various communication services.

The broadcasting system 100 provides a digitally compressed high definition broadcasting program. Hereinafter, the broadcasting system 100 is assumed as a digital data broadcasting system in that data service is provided through an application.

The digital data broadcasting system 100 may further provide a data broadcasting application for use in various additional services and interactive service as well as the video signal/audio signal for a specific channel. Here, the data broadcasting application is formed by combining an application for execution of a program with contents data (e.g., by combining data received from news system, shopping system, stock system with an application).

The broadcasting terminal 102 performs tuning a broadcasting signal transmitted from the digital data broadcasting system 100, and displays an image corresponding to the tuned broadcasting signal. Here, the broadcasting terminal 102 may be a set-top box coupled to a TV for performing decoding of a broadcasting signal and executing an application, but is not limited as the set-top box. That is, any broadcasting terminal can be used as long as it can provide a program guide having an advertisement or advertisements as described below.

The broadcasting terminal 102 processes the broadcasting program (video signal, audio signal and data signal) corresponding to a channel selected by the user of the tuned broadcasting signal, and then provides the processed broadcasting program to the user.

An operating system is set in the broadcasting terminal 102 so as to execute the application. Here, for example, the operating system may execute a data broadcasting application in case that the broadcasting signal has the application, thereby providing the data combined with the application to the user.

The application outputs an interface for request of a certain service by the user through a given display section, parses the data combined therewith in accordance with the request of the user, and outputs contents having the data such as text and graphic.

As described above, in case that the broadcasting terminal 102 provides a video signal converted into a digital format and receives a data broadcasting application for additional service, much broadcasting standby time is required when a user switches channels. Accordingly, the broadcasting terminal 102 may provide a program guide so that the user may select a channel easily, thereby enabling the user to verify information concerning plural channels in a easy and simple manner.

In one example embodiment of the present invention, the broadcasting terminal 102 may generate a program guide having an advertisement or advertisements on the basis of user preferences, etc. Particularly, the digital data broadcasting system 100 transmits a video source for the program guide to the broadcasting terminal 102. Here, the video source may include a sub-video or sub-videos (i.e., a broadcasting sub-video or sub-videos and an advertisement sub-video or sub-videos). The sub-video and sub-videos are generated by processing (downsizing) a video signal or signals for at lease one broadcasting program and at least one advertisement and are shown on a predetermined section or sections of a program guide image outputted from the broadcasting terminal 102.

In addition, the broadcasting sub-video may be a real-time or non-real-time moving picture being broadcasted or having been broadcasted in a corresponding channel, a still image or images thereof, or a combination of the moving picture and the still image. Similarly, the advertisement sub-video may be a real-time or non-real-time moving picture, a still image thereof, or a combination thereof.

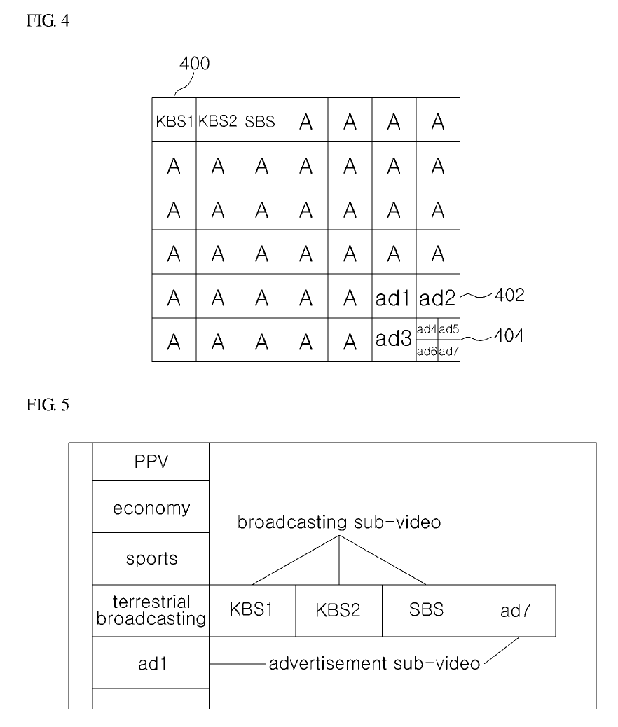

On the other hand, the video source may include the sub-videos for all or a part of the broadcasting programs that can be provided to the broadcasting terminal 102, as shown in FIG. 4.

In one example embodiment of the present invention, the digital data broadcasting system 100 uses an encoding method in accordance with H.264 standard having high compression efficiency to encode the video source for the program guide, thereby enabling the video source to include a number of sub-videos. Here, the H.264 is a recently developed moving picture compression standard to transmit a moving picture with a bandwidth smaller than HD TV, and is referred to as MPEG-4 part 10: advanced video coding (AVC). The H.264 ensures video compressibility enhanced by about 50% compared to conventional MPEG4 in terms of bit rates.

As described above, conventional broadcasting systems transmit a mosaic EPG having a limited number of sub-videos through a tool such as a mosaic screen generator. In addition, the broadcasting systems should generate different mosaic EPGs in case that sub-videos in the mosaic EPGs are differently arranged. Additionally, in case that a mosaic EPG having an advertisement sub-video or sub-videos is provided, only the same advertisement sub-video or sub-videos are provided to every user.

However, digital data broadcasting systems 100 of the present invention can provide a video source having sub-videos for all available broadcasting programs and advertisements by using an improved compression technique. Hence, various advertisements may be provided to the users in a limited bandwidth.

The video source having advertisement sub-video or sub-videos is transmitted to the broadcasting terminal 102. The broadcasting terminal 102 performs an editing process, etc. in accordance with a preset condition, and outputs a program guide having the advertisement sub-video or sub-videos. Here, the preset condition can be set in a manner to match user preferences. For example, it can be set on the basis of a user's subscription information, information about service package selected by the user, information about the user's channel selection.

Based on the information, the broadcasting terminal 102 may determine which advertisement sub-video is to be included in the program guide, and the number, size and location of the advertisement sub-video to be included in the program guide. In addition, the broadcasting terminal 102 may extract from the video source the advertisement sub-video determined to be included.

Broadcasting programs may include videos on demand (VODs) provided by user's request. In another example embodiment of the present invention, in case that a program guide is provided for the VODs, the video source for the program guide may include a sub-video or sub-videos for all or a part of the VODs.

FIG. 5 is a view illustrating a program guide according to one example embodiment of the present invention. The program guide of the present embodiment may output a certain advertisement or advertisements on a predetermined section or sections.

As described above, the digital data broadcasting systems 100 transmit to the broadcasting terminal 102 the broadcasting sub-video or sub-videos for at least one broadcasting program and the advertisement sub-video or sub-videos for at least one advertisement. The broadcasting terminal 102 generates the program guide having one or more of advertisements in accordance with a preset condition. With the systems, bandwidth usage can be remarkably improved compared with the conventional techniques in which different EPGs for different broadcasting programs are provided. In addition, advertisement services can be provided according to user preferences.

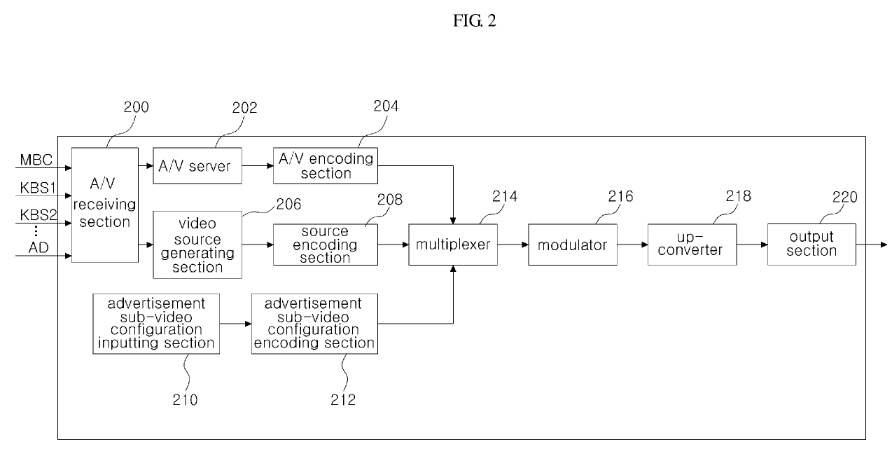

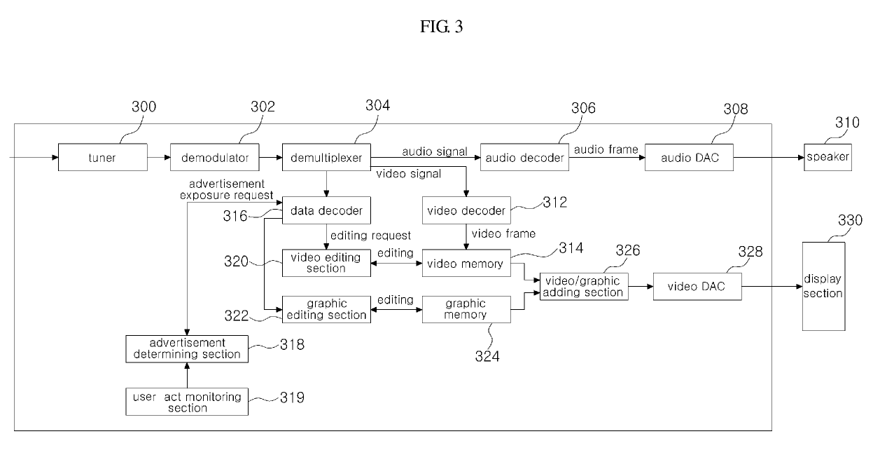

Hereinafter, a system and a method for providing advertisement services according to the present invention will be described in detail with reference to accompanying FIG. 2 and FIG. 3.

FIG. 2 is a block diagram illustrating a digital data broadcasting system according to one example embodiment of the present invention.

In FIG. 2, an audio/video (A/V) receiving section 200 receives a broadcasting signal having an audio signal and a video signal provided from an external broadcasting provider or a terrestrial broadcasting station.

Additionally, the A/V receiving section 200 receives an advertisement broadcasting signal AD having an audio signal and a video signal from an external advertisement sub-video provider.

An A/V server 202 collects and manages the received broadcasting signal, and outputs the broadcasting signal to an A/V encoding section 204.

The A/V encoding section 204 converts the received audio signal and the video signal into a predetermined data format. In one example embodiment of the present invention, the A/V encoding section 204 may convert the audio signal and the video signal into a moving picture experts group2-transport stream (MPEG2-TS) format corresponding to standard of the data broadcasting.

The video signal of the broadcasting signal, which is received by the A/V receiving section 200, is also provided to a video source generating section 206 for the program guide.

The video source generating section 206 generates a plurality of sub-videos for the broadcasting program and the advertisement to be provided by processing the provided video signal. Here, as mentioned above, the sub-video may be generated by downsizing the provided video signal so that it can be shown on the program guide.

In one example embodiment of the present invention, the video source generating section 206 may generate a video source for the program guide having at least one broadcasting sub-video 400 and at least one advertisement sub-video 402, 404. Here, ad1 to ad3 may be processed to have different size from ad4 to ad7. This processing is for transmitting more advertisements in predetermined transmission capacity. The size of the advertisement sub-video may be determined in accordance with various factors such as subscription condition by an advertiser or exposure number of the advertisement sub-video, etc. For example, the advertisement sub-video registered at a high price or having a high exposure number may be displayed in a larger size. Here, a resolution may differ in accordance with the size of the advertisement sub-video.

The generated video source, which has the broadcasting sub-video or sub-videos for all available channels and the advertisement sub-video or sub-videos, is transmitted to a video source encoding section 208.

The video source encoding section 208 encodes the transmitted video source in accordance with a preset algorithm. Preferably, the video source encoding section 208 encodes the sub-videos by using an algorithm in accordance with H.264 compression standard.

The video source encoding section 208 may be embodied as a high definition HD chip set. As a result, the video source encoding section 208 can encode the video source to have high compression efficiency while maintaining high definition.

On the other hand, the digital data broadcasting system 100 transmits information concerning configuration of the advertisement sub-video or sub-videos (hereinafter, referred to as “advertisement sub-video configuration information”) to the broadcasting terminal 102 so that the broadcasting terminal 102 can output a program guide having the advertisement sub-video or sub-videos included in the video source.

An advertisement sub-video configuration inputting section 210 receives the advertisement sub-video configuration information inputted by a system manager. Here, the advertisement sub-video configuration information includes information concerning identifier ID and size of the advertisement sub-video or sub-videos included in the video source, as shown in FIG. 4. The advertisement sub-video configuration information may be properly selected in accordance with characteristic of a network for example, caption of a digital broadcasting, a data broadcasting technique, or a teletext technique of an analog broadcasting, etc.

In one example embodiment of the present invention, the advertisement sub-video configuration information may further include location information corresponding to X coordinate and Y coordinate. Here, the location information may be used for arranging respective advertisement sub-videos included in the program guide in case that the sub-videos for broadcasting programs of every available channel and the advertisement or advertisements are outputted at a time as shown in FIG. 4. Also, in case that the broadcasting terminal 102 dynamically determines whether or not the program guide includes an advertisement sub-video and the location and size of the advertisement sub-video, the above location information may or may not be included in the advertisement sub-video configuration information.

The advertisement sub-video configuration information is encoded by an advertisement sub-video configuration encoding section 212, and then the encoded information is outputted to a multiplexer 214.

The multiplexer 214 makes the signals provided from the A/V encoding section 204, the video source encoding section 208 and the advertisement sub-video configuration encoding section 212 into one broadcasting signal to be broadcasted.

A modulator 216 modulates the broadcasting signal in accordance with the standard of a broadcasting medium, e.g. terrestrial broadcasting, cable broadcasting, satellite broadcasting.

An up-converter 218 up-converts the modulated broadcasting signal to have a frequency to be transmitted.

An output section 220 outputs the up-converted broadcasting signal through a broadcasting medium.

FIG. 3 is a block diagram illustrating a broadcasting terminal according to one example embodiment of the present invention.

The broadcasting terminal 102 of the present embodiment may be a set-top box coupled to a TV to provide a digital data broadcasting service.

In FIG. 3, a tuner 300 outputs selectively a broadcasting signal for a corresponding channel of the received broadcasting signals with synchronization with a given frequency.

A demodulator 302 demodulates the broadcasting signal outputted from the tuner 300. Here, the demodulated broadcasting signal includes an audio signal, a video signal and data signal, and the demodulator 304 extracts the audio signal, the video signal and the data signal from the demodulated broadcasting signal, and outputs the extracted signals. This may be performed through demuxing and section filtering.

The audio signal outputted from the demultiplexer 304 is decoded by an audio decoder 306. The decoded audio signal is converted into an analog signal through an audio digital analog converter (DAC) 308, and then the converted audio signal is outputted through a speaker 310.

The video signal outputted from the demultiplexer 304 is outputted as video frame not compressed by decoded by a video decoder 312. The video frame is temporarily stored in a video memory 314. The video memory 314 stores temporarily a still image of the video frame.

On the other hand, to output a program guide having an advertisement sub-video or sub-videos, the demultiplexer 304 outputs the advertisement sub-video configuration information data to a data decoder 316. In this case, the data decoder 316 may request a video editing section 320 to edit the advertisement sub-video or sub-videos in accordance with an advertisement exposure request signal from an advertisement determining section 318. Here, the advertisement determining section 318 may determine whether to include an advertisement sub-video in the program guide, and the number, size and location of the advertisement sub-video in accordance with a preset condition such as user's subscription information, subscription service package information and channel selection preference information stored in a user's act monitoring section 319.

The user's subscription information may include information about, for example, user's age, sex and area. The subscription service package information may include information as to, for instance, whether or not the user agrees to exposure of the advertisement.

In case that the advertisement determining section 318 requests exposure of the advertisement, the data decoder 316 decodes the advertisement sub-video configuration information transmitted from the digital data broadcasting system 100, and requests an editing process to the video editing section 320.

The video editing section 320 performs the editing process such as a process of clipping desired area, a scaling process and a transiting process through the video frame stored temporarily in the video memory 314.

In one example embodiment of the present invention, the video signal outputted from the demultiplexer 304 includes sub-video signals for at least one broadcasting program and at least one advertisement. The video editing section 320 performs the editing of the broadcasting sub-video or sub-videos and the advertisement sub-video or sub-videos included in the video source in case that it is determined that the advertisement is exposed. Particularly, the video editing section 320 may select only an advertisement sub-video corresponding to the user's preference from the advertisement sub-videos. In addition, the video editing section 320 may adjust the size of an advertisement sub-video through interpretation of the advertisement sub-video configuration information. That is, the video editing section 320 may increase or reduce the size of the advertisement sub-video or subvideos.

The graphic editing section 322 extracts a graphic corresponding to the program guide from a graphic memory 324, and edits the extracted graphic. Here, the graphic may have a preset background image to be outputted with the program guide for selection of the channel.

A video/graphic adding section 326 adds to the graphic provided from the graphic memory 324 a still image (in a unit of a frame) stored in the video memory 314 (i.e., a still image of the sub-video frame selected in accordance with the user's preference).

The thus-generated video/graphic is transmitted to a video DAC 328.

The video DAC 328 converts the digital video/graphic into an analog signal, and then outputs the converted video/graphic to a display section 330.

A program guide outputted from the display section 330 may have an advertisement sub-video or sub-videos on a given section or sections.

The number of the advertisement sub-video can be adjusted. For example, as shown in FIG. 5, the program guide may include only the advertisement sub-videos ad1 and ad7 out of the advertisement sub-videos ad1 to ad7 (FIG. 4) in accordance with a preset condition. In addition, the size of the advertisement sub-video can be adjusted. For example, the size of ad 1 may be set to be larger than that of ad 7. Also, the location of the advertisement sub-video can be adjusted. For example, the advertisement sub-video may be arranged in parallel to the broadcasting sub-video having the same genre as the advertisement sub-video.

The user may search broadcasting sub-video or sub-videos and advertisement sub-video or sub-videos through the program guide as shown in FIG. 5.

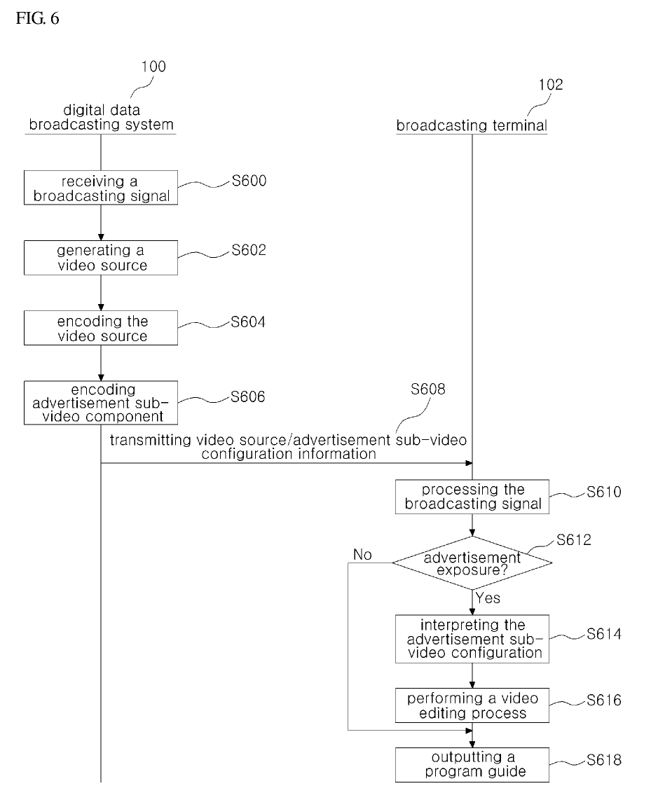

Hereinafter, a process of providing advertisements through the program guide will be described in detail with reference to accompanying FIG. 6.

Referring to FIG. 6, in step of S600, the digital data broadcasting system 100 receives a broadcasting signal for a broadcasting program and an advertisement signal from an external broadcasting provider or a terrestrial broadcasting station. The signals may include a video signal and an audio signal.

In step of S602, the digital data broadcasting system 100 generates a video source for the program guide by processing the video signal for the broadcasting program and the advertisement.

In step of S604, the digital data broadcasting system 100 encodes the video source in accordance with a predetermined algorithm.

In step of S606, the digital data broadcasting system 100 receives an advertisement sub-video configuration information, and then encodes the received configuration information. Here, the advertisement sub-video configuration information may include the information concerning identifier and size of the advertisement sub-video included in the video source, as described above. The step S606 may be performed before or after the step S604.

In step of S608, the encoded video source and the advertisement sub-video configuration information are transmitted to the broadcasting terminal 102.

In step of S610, the video source and the advertisement sub-video configuration information are processed by the broadcasting terminal 102. In particular, the broadcasting terminal 102 extracts the video source and the advertisement sub-video configuration information from the transmitted broadcasting signal through the demodulating, demuxing, etc.

In step of S612, in case that output of the program guide is requested, the broadcasting terminal 102 determines whether to include an advertisement (sub-video) in the program guide.

In case that it is determined that the advertisement is to be included in the program guide, in step of S614, the broadcasting terminal 102 interprets the advertisement sub-video configuration information, and then, in step of S616, performs a video editing process through the interpreted result.

In step of S618, the broadcasting terminal 102 outputs the program guide having only an advertisement sub-video or sub-videos that match the user's preference.

The method for providing advertisements in digital broadcasting systems according to the above-described embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the configuration parts and/or arrangements of the subject combination arrangement within the scope of the disclosure, the drawings and the appended claims. In addition to variations and modifications in the configuration parts and/or arrangements, alternative uses will also be apparent to those skilled in the art.

1. A method of providing an advertisement in a broadcasting system coupled to at least one broadcasting terminal through a network, the method comprising:
generating a video source for a program guide by processing a video signal for at least one broadcasting program and at least one advertisement;
encoding the generated video source by using a predetermined algorithm; and
transmitting the encoded video source to the broadcasting terminal or terminals,
wherein the broadcasting terminal outputs a program guide having one or more of advertisement sub-videos included in the video source, the advertisement sub-video or sub-videos being selected in accordance with a predetermined condition.

2. The method of claim 1, wherein the advertisement sub-videos are different in size.

3. The method of claim 2, wherein the size of the advertisement sub-video is determined in accordance with at least one criteria selected from the group comprising advertisement subscription condition by an advertiser, exposure number of the advertisement sub-video and selection number of the advertisement sub-video by a user.

4. The method of claim 1, wherein the video source includes broadcasting sub-videos for all broadcasting programs of every available channel.

5. The method of claim 1, wherein the step of encoding is performed by H.264 compression standard, and the step of transmitting is performed by transmitting the encoded video source through one channel.

6. The method of claim 1, further comprising:
transmitting to the broadcasting terminal or terminals an advertisement sub-video configuration information which includes information concerning identifier of the respective advertisement sub-videos, information concerning size of the respective advertisement sub-videos, or both.

7. The method of claim 1, wherein the broadcasting terminal determines whether or not the advertisement sub-video or sub-videos are to be included in the program guide, number of the advertisement sub-video to be included in the program guide, and size and location of the advertisement sub-video or sub-videos in accordance with at least one criteria selected from the group comprising user's subscription information, subscription service package information and user's channel selection preference information.

8. A method of providing an advertisement in a broadcasting terminal for executing a broadcasting program transmitted from a broadcasting system through a network, the method comprising:
receiving a video source for a program guide from the broadcasting system through the network, wherein the video source has sub-videos (broadcasting sub-video and advertisement sub-video) for at least one broadcasting program and at least one advertisement and is encoded by a preset algorithm; and
outputting the program guide having one or more of advertisement sub-videos included in the video source, the advertisement sub-video or sub-videos being selected in accordance with a predetermined condition.

9. The method of claim 8, wherein the step of outputting the program guide includes:
determining whether or not the advertisement sub-video or sub-videos are to be included in the program guide in accordance with the predetermined condition;
determining number of the advertisement sub-video to be included in the program guide, and size and location of the advertisement sub-video or sub-videos; and
extracting from the video source the advertisement sub-video or sub-videos determined to be included in the program guide.

10. The method of claim 8, wherein the program guide is outputted by at least one criteria selected from the group comprising user's subscription information, subscription service package information and user's channel selection preference information.

11. The method of claim 8, further comprising:
receiving from the broadcasting system through the network an advertisement sub-video configuration information which includes information concerning identifier of the respective advertisement sub-videos and information concerning size of the respective advertisement sub-videos, or both,
wherein the step of outputting the program guide includes editing the respective advertisement sub-video by using the advertisement sub-video configuration information.

12. The method of claim 11, wherein the advertisement sub-video configuration information further includes information concerning location of the respective advertisement sub-videos.

13. The method of claim 11, wherein the step of outputting the program guide includes increasing or reducing the size of a part or all of the advertisement sub-videos in accordance with the predetermined condition.

14. A system for providing a broadcasting service to at least one broadcasting terminal through a network, the system comprising:
a video source generating section configured to generate a video source by processing a video signal for at least one broadcasting program and at least one advertisement; and
a source encoding section configured to encode the generated video source by using a preset algorithm,
wherein the broadcasting terminal outputs a program guide having one or more of advertisement sub-videos included in the video source, the advertisement sub-video or sub-videos being selected in accordance with a predetermined condition.

15. The system of claim 14, wherein the video source generating section generates the video source for all broadcasting programs of every available channel, and the source encoding section encodes the video source to one file in accordance with H.264 compression standard.

16. The system of claim 14, wherein the video source generating section generates the video source, which includes the advertisement sub-videos having different sizes in accordance with at least one criteria selected from the group comprising advertisement subscription condition by an advertiser, exposure number of the advertisement sub-video and selection number of the advertisement sub-video.

17. A computer-readable storage medium storing a program for implementing the method of claim 1.

18. A computer-readable storage medium storing a program for implementing the method of claim 8.
